(19) United States
(12) Patent Application Publication
(10) Pub. No.: US 2024/0231514 A1
(43) Pub. Date: Jul. 11, 2024

(54) LUMINOUS TOUCH PAD

(71) Applicant: Primax Electronics Ltd., Taipei (TW)

(72) Inventors: Jia-Hung Lin, Taipei (TW); Che-Wei Lee, Taipei (TW); Yu-Zeng Yang, Taipei (TW); Hui-Ling Lin, Taipei (TW)

(21) Appl. No.: 18/120,740

(22) Filed: Mar. 13, 2023

(30) Foreign Application Priority Data
Jan. 11, 2023 (TW) 112101261

(51) Int. Cl. G06F 3/0354

(52) U.S. Cl. CPC G06F 3/03547

(57) ABSTRACT

A luminous touch pad includes a covering plate, a circuit board, a light guide structure and a first light-shading adhesive. The covering plate includes a first surface and a second surface. The circuit board is located under the covering plate. The circuit board includes a third surface and a fourth surface. The light guide structure is arranged between the covering plate and the circuit board. The light guide structure includes a lateral surrounding surface. An adhesive receiving space is defined by the lateral surrounding surface, a portion of the second surface and a portion of the third surface collaboratively. The first light-shading adhesive is disposed within the adhesive receiving space and arranged around the light guide structure. The first light-shading adhesive is contacted with the portion of the second surface, the portion of the third surface and the lateral surrounding surface.

### FIELD OF THE INVENTION

The present invention relates to an input device, and more particularly to a luminous touch pad.

### BACKGROUND OF THE INVENTION

Nowadays, notebook computers become essential tools for modern people in their daily lives. The user can operate an external mouse device to control a notebook computer. In addition, the notebook computer is usually equipped with a touch pad. The user can move a cursor or perform a clicking control operation through the touch pad.

Conventionally, the touch pad can be touched or pressed to execute the corresponding function. With the advancement of the touch control technology and the backlight technology, the main body of the touch pad has an illumination function. Furthermore, the touch pad provides a built-in key input function. Due to the arrangement of the touch pad, the notebook computer is additionally equipped with hot keys. More especially, the notebook computer additionally has a numeric keypad through the touch pad. For example, when a specified position of the touch pad is pressed down, a backlight module under the touch pad is enabled, and plural numbers or symbols are displayed. At the same time, the regions of the touch pad corresponding to the displayed numbers or symbols are changed to corresponding key regions. When one key region of the touch pad is touched by the user, the function of inputting a corresponding digital number (or symbol), a Backspace function, an Enter function or an associated function is executed. Consequently, even if the notebook computer is not connected with an external numeric keypad, the notebook computer can provide the key input function quickly.

After the touch pad is installed on a lower housing of the notebook computer, an assembling gap between the touch pad and the lower housing of the notebook computer is created certainly. When the touch pad is in an illumination mode, the light beam emitted by the light source may be exited from the end surface of the touch pad and leaked out through the assembling gap. Consequently, a light leakage problem is generated.

However, in most of the existing technologies, a black plastic material is subjected to a die-cutting process to create a black light-shading frame with a hollow rectangle profile. Due to the arrangement of the black light-shading frame, the light beam is blocked from being leaked out through the end surface of the touch pad. Consequently, the problem of leaking out the light beam through the assembling gap can be solved. However, since the method using the die-cutting process to create the black light-shading frame wastes a lot of material, the material utilization is low. In addition, for assembling the black light-shading frame on the region between a touch circuit board and a glass covering plate, multiple layers of black double-sided tapes are required. Consequently, the process of assembling and producing the touch pad is long and complicated. Moreover, when the black double-sided tape is aging, the black double-sided tape often peels off, and thus the adhesive efficacy is deteriorated. Under this circumstance, the assembling yield of the touch pad is reduced. After the black double-sided tape peels off, an additional gap is generated, and the light leakage problem occurs again.

Therefore, there is a need of providing an improved luminous touch pad in order to overcome the above drawbacks.

### SUMMARY OF THE INVENTION

An object of the present invention provides a luminous touch pad with the function of preventing from the light leakage problem. Due to the special design, the structure of the luminous touch pad is simplified, and the fabricating cost is effectively reduced.

The other objects and advantages of the present invention will be understood from the disclosed technical features.

In accordance with an aspect of the present invention, a luminous touch pad is provided. The luminous touch pad includes a covering plate, a circuit board, a light guide structure and a first light-shading adhesive. The covering plate includes a first surface and a second surface. The first surface and the second surface are opposed to each other. The circuit board is located under the covering plate. The circuit board includes a third surface and a fourth surface. The third surface and the fourth surface are opposed to each other. The third surface faces the second surface of the covering plate. The light guide structure is arranged between the covering plate and the circuit board. The light guide structure includes a lateral surrounding surface. An adhesive receiving space is defined by the lateral surrounding surface, a portion of the second surface and a portion of the third surface collaboratively. The first light-shading adhesive is disposed within the adhesive receiving space and arranged around the light guide structure. The first light-shading adhesive is contacted with the portion of the second surface, the portion of the third surface and the lateral surrounding surface.

In an embodiment, the light guide structure includes a light-guiding plate, a reflective layer and an adhesive layer, which are stacked on each other from top to bottom. The light-guiding plate is arranged between the covering plate and the reflective layer. The adhesive layer is arranged between the reflective layer and the circuit board. The light-guiding plate includes a light-guiding plate lateral surface. The reflective layer includes a reflective layer lateral surface. The adhesive layer includes an adhesive layer lateral surface. The light-guiding plate lateral surface, the reflective layer lateral surface and the adhesive layer lateral surface are collaboratively formed as the lateral surrounding surface.

In an embodiment, the light-guiding plate further includes a light output surface and a bottom surface. The light output surface and the bottom surface are opposed to each other. The light-guiding plate lateral surface is arranged between the light output surface and the bottom surface. The light-guiding plate lateral surface includes a light input part. The light input part includes at least one notch.

In an embodiment, the luminous touch pad further includes at least one light-emitting element. The at least one light-emitting element is disposed within the at least one notch of the light input part. The at least one light-emitting element is electrically connected with the circuit board. The at least one light-emitting element emits a light beam. The light beam is introduced into the light-guiding plate through the light input part. The light beam is outputted from the light output surface.

In an embodiment, the luminous touch pad further includes a second light-shading adhesive, and the light guide structure further includes plural light-shading holes. The lateral surrounding surface is arranged around the plural light-shading holes. The plural light-shading holes are extended along a first direction. The plural light-shading holes are discretely arranged along a second direction. The first direction and the second direction are not in parallel with each other. The second light-shading adhesive is formed in the plural light-shading holes.

In an embodiment, the covering plate has a first width, the circuit board has a second width, the light guide structure has a third width, and each of the first width and the second width is larger than the third width. When the covering plate, the light guide structure and the circuit board are stacked on each other from top to bottom, the adhesive receiving space is defined by the lateral surrounding surface of the light guide structure, the portion of the second surface of the covering plate and the portion of the third surface of the circuit board collaboratively.

In accordance with an aspect of the present invention, a luminous touch pad is provided. The luminous touch pad includes a covering plate, a circuit board, a light guide structure and a first light-shading adhesive. The covering plate includes a first surface and a second surface. The first surface and the second surface are opposed to each other. The circuit board is located under the covering plate. The circuit board includes a third surface, a fourth surface and an end surface. The third surface and the fourth surface are opposed to each other. The end surface is arranged between the third surface and the fourth surface. The third surface faces the second surface of the covering plate. The light guide structure is arranged between the covering plate and the circuit board. The light guide structure includes a lateral surrounding surface. An adhesive receiving space is defined by the lateral surrounding surface, the end surface and a portion of the second surface collaboratively. The first light-shading adhesive is disposed within the adhesive receiving space and arranged around the light guide structure and the circuit board. The first light-shading adhesive is contacted with the portion of the second surface, the end surface and the lateral surrounding surface.

In an embodiment, the luminous touch pad further includes a second light-shading adhesive, and the light guide structure further includes plural light-shading holes. The lateral surrounding surface is arranged around the plural light-shading holes. The plural light-shading holes are extended along a first direction. The plural light-shading holes are discretely arranged along a second direction. The first direction and the second direction are not in parallel with each other. The second light-shading adhesive is formed in the plural light-shading holes.

In an embodiment, the lateral surrounding surface of the light guide structure and the end surface of the circuit board are coplanar with each other.

In an embodiment, the covering plate has a first width, the circuit board has a second width, the light guide structure has a third width, each of the second width and the third width is smaller than the third width, and the second width is equal to the third width. When the covering plate, the light guide structure and the circuit board are stacked on each other from top to bottom, the adhesive receiving space is defined by the lateral surrounding surface of the light guide structure, the portion of the second surface of the covering plate and the end surface of the circuit board collaboratively.

From the above descriptions, the present invention provides the luminous touch pad. After the covering plate, the light guide structure and the circuit board are stacked on each other, the adhesive receiving space is formed in the edge regions of the covering plate, the light guide structure and the circuit board. In addition, the light-shading adhesive is directly filled in the adhesive receiving space through the dispensing process. Consequently, the covering plate, the circuit board and the light guide structure are attached and fixed on each other through the light-shading adhesive. Moreover, due to the arrangement of the first light-shading adhesive, the leakage of the light beam through the lateral surrounding surface of the light guide structure can be avoided.

The luminous touch pad has the following advantages. Firstly, the light-shading adhesive is used to replace the black light-shading frame of the conventional touch pad. Consequently, the stack structure with the double-sided tapes is not required. That is, the covering plate, the circuit board and the light guide structure are attached and fixed on each other through the light-shading adhesive. Consequently, the stack structure is simplified and thinned. Secondly, since the light-shading adhesive is used to replace the black light-shading frame of the conventional touch pad, the material loss problem of using the die-cutting process to create the black light-shading frame according to the conventional technology is solved, the number of fabricating steps is largely reduced, and the fabricating cost is effectively reduced. Thirdly, after the light-shading adhesive is solidified, the light-shading adhesive still has the property to be subjected to the tiny elastic change. Consequently, if the environment change of the product is drastic, the light-shading adhesive is not easily peeled off when compared with the double-sided tapes. Consequently, the light leakage problem will be avoided. Fourthly, the color of the light-shading adhesive is not restricted. As long as the light-shading adhesive is able to effectively shade the light beam, the color of the light-shading adhesive is not restricted.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a luminous touch pad according to a first embodiment of the present invention;

FIG. 2 is a schematic exploded view illustrating the luminous touch pad as shown in FIG. 1;

FIG. 3 is a schematic cross-sectional view illustrating the luminous touch pad as shown in FIG. 1 and taken along the line AA;

FIG. 4 is a schematic cross-sectional view illustrating the luminous touch pad as shown in FIG. 1 and taken along the line BB;

FIG. 5 is a schematic perspective view illustrating the appearance of a luminous touch pad according to a second embodiment of the present invention;

FIG. 6 is a schematic exploded view illustrating the luminous touch pad as shown in FIG. 5;

FIG. 7 is a schematic cross-sectional view illustrating the luminous touch pad as shown in FIG. 5 and taken along the line CC; and

FIG. 8 is a schematic exploded view illustrating a luminous touch pad according to a third embodiment of the present invention.

### DETAILED DESCRIPTION OF THE PREFERRED EMBODIMENT

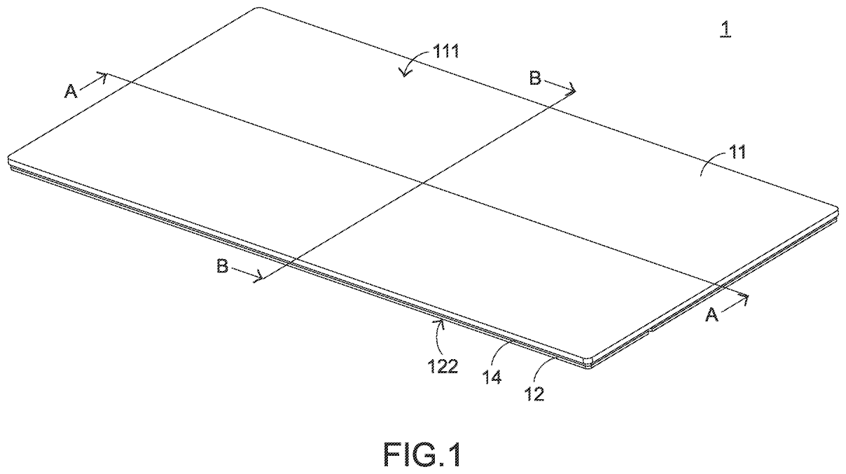

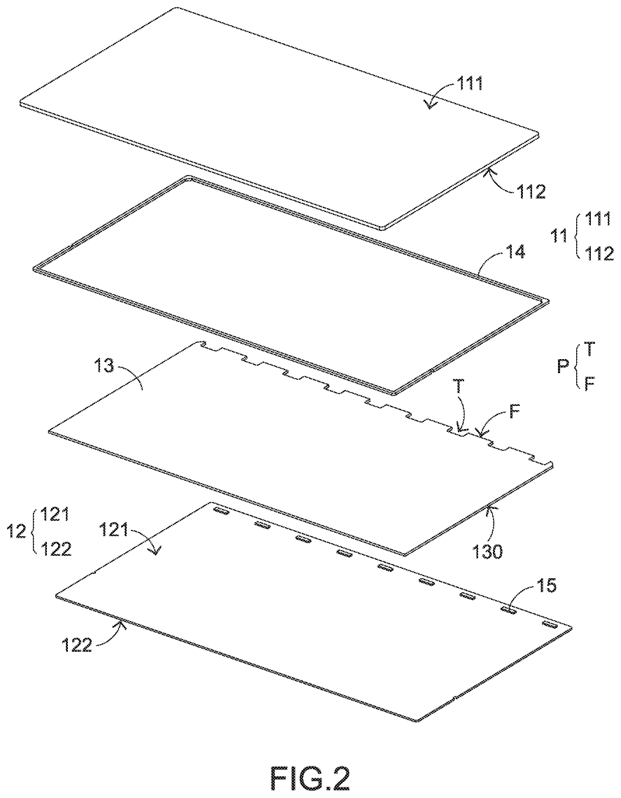

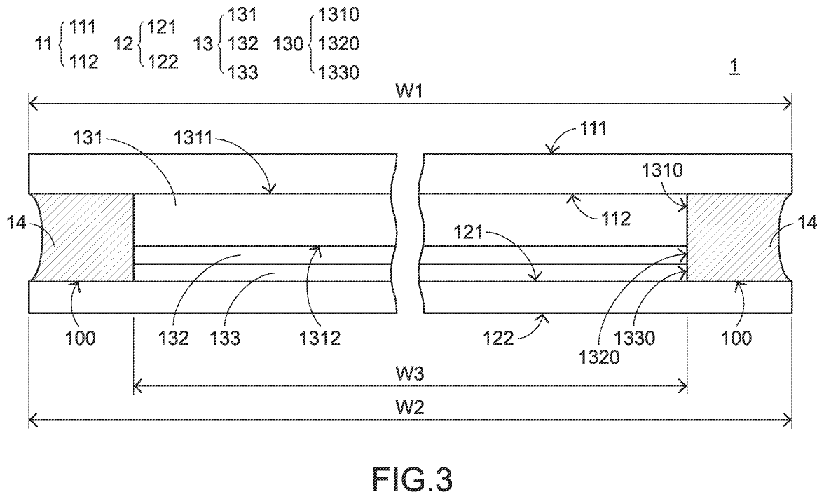

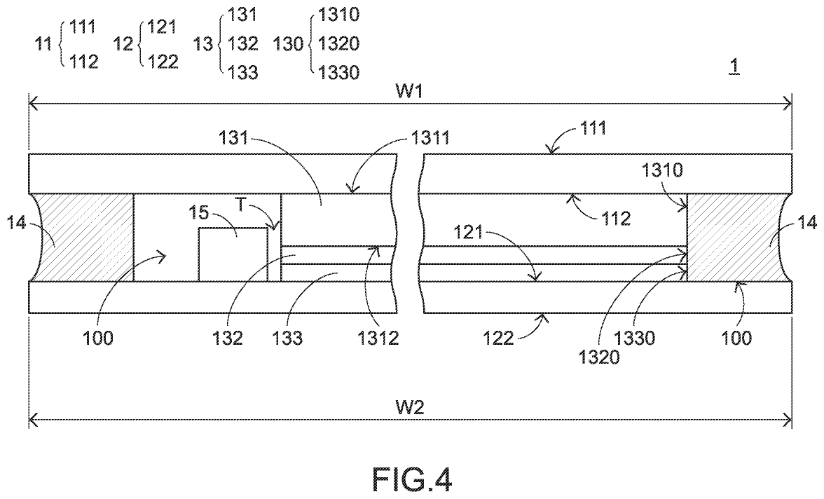

Please refer to FIGS. 1, 2, 3 and 4. FIG. 1 is a schematic perspective view illustrating the appearance of a luminous touch pad according to a first embodiment of the present invention. FIG. 2 is a schematic exploded view illustrating the luminous touch pad as shown in FIG. 1. FIG. 3 is a schematic cross-sectional view illustrating the luminous touch pad as shown in FIG. 1 and taken along the line AA. FIG. 4 is a schematic cross-sectional view illustrating the luminous touch pad as shown in FIG. 1 and taken along the line BB.

As shown in FIG. 1, the luminous touch pad 1 is a multifunctional touch pad that is a combination of a touch panel and a backlight module. The luminous touch pad 1 is installed in a fixing frame of a bottom housing of a notebook computer. The luminous touch pad 1 is electrically connected with a processor of the notebook computer. At least a portion of the luminous touch pad 1 is exposed outside so as to be touched by the user's finger. Consequently, the notebook computer can be operated by the user. In a general usage mode, the luminous touch pad 1 is not illuminated. Under this circumstance, the operations of the luminous touch pad 1 are similar to those of the general touch panel. When the user's finger is placed on the luminous touch pad 1 and slid on the luminous touch pad 1, a mouse cursor is correspondingly moved. Moreover, in case that the luminous touch pad 1 is pressed down by the user's finger, the notebook computer executes a specific function. In a luminous usage mode, specific patterns, characters or symbols are displayed on the luminous touch pad 1. For example, a virtual numeric keypad is displayed on the luminous touch pad 1. According to the touch signal from the luminous touch pad, the processor of the notebook computer performs the operation corresponding to the pressed number or symbol.

The other structures of the luminous touch pad 1 will be described in more details as follows.

Please refer to FIGS. 1, 2, 3 and 4 again. In this embodiment, the luminous touch pad 1 comprises a covering plate 11, a circuit board 12, a light guide structure 13 and a first light-shading adhesive 14.

The covering plate 11 comprises a first surface 111 and a second surface 112. The first surface 111 and the second surface 112 are opposed to each other. The covering plate 11 is made of glass or any other appropriate material. The circuit board 12 is located under the covering plate 11. The circuit board 12 comprises a third surface 121 and a fourth surface 122. The third surface 121 and the fourth surface 122 are opposed to each other. The third surface 121 of the circuit board 12 and the second surface 112 of the covering plate 11 face each other.

The light guide structure 13 is arranged between the covering plate 11 and the circuit board 12. The light guide structure 13 comprises a lateral surrounding surface 130. After the covering plate 11, the light guide structure 13 and the circuit board 12 are stacked on each other from top to bottom, an adhesive receiving space 100 is defined by the lateral surrounding surface 130 of the light guide structure 13, a portion of the second surface 112 of the covering plate 11 (i.e., the edge portion of the second surface 112 of the covering plate 11) and a portion of the third surface 121 of the circuit board 12 (i.e., the edge portion of the third surface 121 of the circuit board 12) collaboratively.

The first light-shading adhesive 14 is disposed within the adhesive receiving space 100. In addition, the first light-shading adhesive 14 is arranged around the light guide structure 13. The first light-shading adhesive 14 is contacted with the portion of the second surface 112 of the covering plate 11, the portion of the third surface 121 of the circuit board 12 and the lateral surrounding surface 130 of the light guide structure 13.

In this embodiment, the first light-shading adhesive 14 is filled in the adhesive receiving space 100 through a dispensing process. After the first light-shading adhesive 14 is filled in the adhesive receiving space 100, the first light-shading adhesive 14 is attached on the portion of the second surface 112 of the covering plate 11, the portion of the third surface 122 of the circuit board 12 and the lateral surrounding surface 130 of the light guide structure 13. Consequently, the covering plate 11, the circuit board 12 and the light guide structure 13 are combined together through the first light-shading adhesive 14. Moreover, due to the light-shading characteristics of the first light-shading adhesive 14, the leakage of the light beam through the lateral surrounding surface 130 of the light guide structure 13 can be avoided.

Preferably but not exclusively, the first light-shading adhesive 14 is a black adhesive. It is noted that the color of the first light-shading adhesive 14 is not restricted. As long as the first light-shading adhesive 14 is able to effectively shade the light beam, the color of the first light-shading adhesive 14 may be modified according to the practical requirements.

In the above embodiment, the first light-shading adhesive 14 is filled in the adhesive receiving space 100 through the dispensing process. However, the method of filling the first light-shading adhesive 14 in the first light-shading adhesive 14 may be varied according to the practical requirements.

Please refer to FIGS. 1, 2, 3 and 4 again. In this embodiment, the light guide structure 13 comprises a light-guiding plate 131, a reflective layer 132 and an adhesive layer 133, which are stacked on each other from top to bottom. The light-guiding plate 131 is arranged between the covering plate 11 and the reflective layer 132. The adhesive layer 133 is arranged between the reflective layer 132 and the circuit board 12. The light-guiding plate 131 comprises a light-guiding plate lateral surface 1310. The reflective layer 132 comprises a reflective layer lateral surface 1320. The adhesive layer 133 comprises an adhesive layer lateral surface 1330. When the light-guiding plate 131, the reflective layer 132 and the adhesive layer 133 are stacked on each other, the light-guiding plate lateral surface 1310, the reflective layer lateral surface 1320 and the adhesive layer lateral surface 1330 are collaboratively formed as the lateral surrounding surface 130 of the light guide structure 13. In other words, after the first light-shading adhesive 14 is filled in the adhesive receiving space 100, the first light-shading adhesive 14 is attached on the light-guiding plate lateral surface 1310, the reflective layer lateral surface 1320 and the adhesive layer lateral surface 1330.

Please refer to FIGS. 1, 2, 3 and 4 again. The light-guiding plate 131 further comprises a light output surface 1311 and a bottom surface 1312. The light output surface 1311 and the bottom surface 1312 of the light-guiding plate 131 are opposed to each other. The light-guiding plate lateral surface 1310 is arranged between the light output surface 1311 and the bottom surface 1312. Moreover, the light-guiding plate lateral surface 1310 comprises a light input part P. The light input part P comprises at least one notch T. In this embodiment, the light-guiding plate 131 is a rectangular plate. The light-guiding plate lateral surface 1310 is defined by four lateral surfaces of the rectangular plate. The light input part P is located at one of the four lateral surfaces.

Please refer to FIGS. 1, 2, 3 and 4 again. The luminous touch pad 1 further comprises at least one light-emitting element 15. The light-emitting element 15 is disposed within the notch T of the light input part P of the light-guiding plate lateral surface 1310. In addition, the at least one light-emitting element 15 is electrically connected with the circuit board 12. In this embodiment, the circuit board 12 further comprises an illumination driving circuit (not shown). The at least one light-emitting element 15 is electrically connected with illumination driving circuit. The illumination driving circuit provides a driving current to drive the light-emitting element 15. Consequently, the light-emitting element 15 emits a light beam. The light beam emitted by the light-emitting element 15 is introduced into the light-guiding plate 131 through the light input part P. After the light beam is subjected to a total internal reflection within the light-guiding plate 131, the light beam is outputted from the light output surface 1311.

In this embodiment, the at least one light-emitting element 15 comprises plural light-emitting elements 15. The number of the at least one notch T of the light input part P is equal to the number of the at least one light-emitting element 15. That is, the at least one notch T includes plural notches T. Each light-emitting element 15 is disposed within the corresponding notch T. In this embodiment, the light input part P of the light-guiding plate lateral surface 1310 further comprises plural flat parts F. Each flat part F is arranged between every two adjacent notches T. After the first light-shading adhesive 14 is filled in the adhesive receiving space 100, the first light-shading adhesive 14 is attached on the flat parts F, and the openings of the notches T are sealed by the first light-shading adhesive 14. In other words, the portion of the first light-shading adhesive 14 formed on the light input part P is not introduced into the notch T. Consequently, the light-emitting element 15 will not be adhered by the first light-shading adhesive 14. Since the light-emitting elements 15 are not adhered by the first light-shading adhesive 14, the electrical connection between the light-emitting element 15 and the circuit board 12 will not be destroyed.

In the above embodiment, the light input part P of the light-guiding plate 131 comprises plural notches T to accommodate the corresponding light-emitting elements 15. As long as the light beam from the light-emitting element 15 can be introduced into the inner of the light-guiding plate 131 through the light input part P of the light-guiding plate 131, numerous modifications and alterations may be made. For example, in another embodiment, the light input part P of the light-guiding plate 131 is equipped with plural openings for accommodating the corresponding light-emitting elements 15. Alternatively, in another embodiment, the light input part P of the light-guiding plate 131 is not equipped with notches or openings, and the light input part P of the light-guiding plate 131 is a flat light input surface. Furthermore, in the above embodiment, the shapes of the notches or the openings are not restricted.

Please refer to FIGS. 1, 2, 3 and 4 again. In this embodiment, the covering plate 11 has a first width W1, the circuit board 12 has a second width W2, and the light guide structure 13 has a third width W3. Each of the first width W1 of the covering plate 11 and the second width W2 of the circuit board 12 is larger than the third width W3 of the light guide structure 13. Consequently, when the covering plate 11, the light guide structure 13 and the circuit board 12 are stacked on each other from top to bottom, the adhesive receiving space 100 can be defined by the lateral surrounding surface 130 of the light guide structure 13, the portion of the second surface 112 of the covering plate 11 and the portion of the third surface 121 of the circuit board 12 collaboratively.

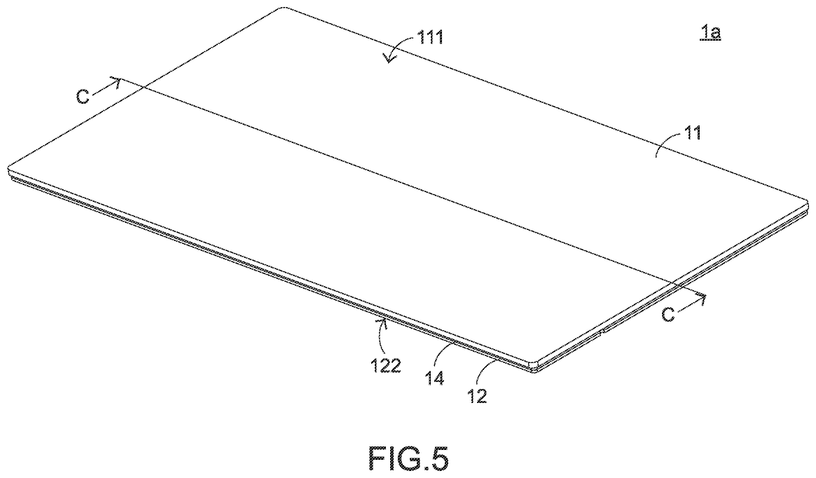

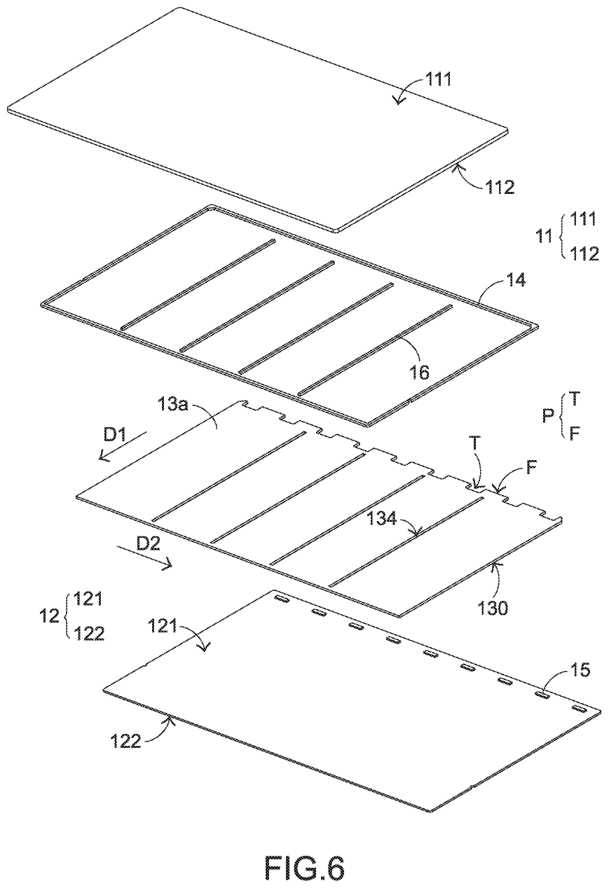

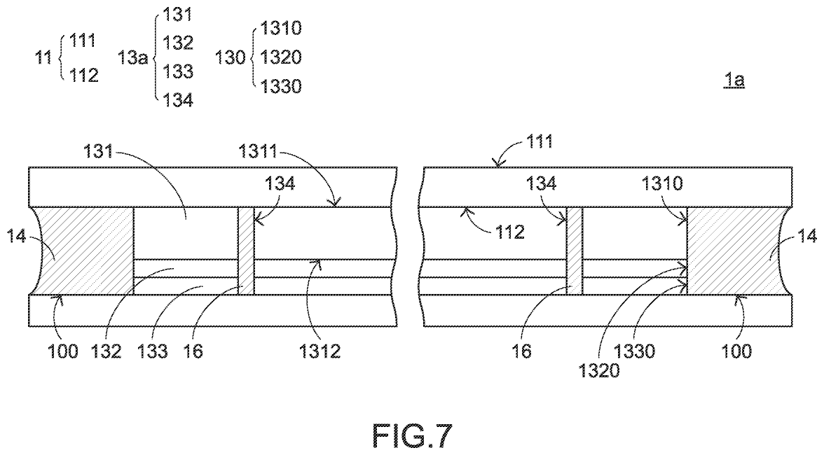

Please refer to FIGS. 5, 6 and 7. FIG. 5 is a schematic perspective view illustrating the appearance of a luminous touch pad according to a second embodiment of the present invention. FIG. 6 is a schematic exploded view illustrating the luminous touch pad as shown in FIG. 5. FIG. 7 is a schematic cross-sectional view illustrating the luminous touch pad as shown in FIG. 5 and taken along the line CC. In comparison with the luminous touch pad 1 as shown in FIGS. 1, 2 and 3, the luminous touch pad 1a of this embodiment further comprises a second light-shading adhesive 16, and the light guide structure 13a further comprises plural light-blocking holes 134. In this embodiment, the lateral surrounding surface 130 of the light guide structure 13a is arranged around these light-blocking holes 134. The plural light-blocking holes 134 are extended along a first direction D1. In addition, the plural light-blocking holes 134 are discretely arranged along a second direction D2. The second direction D2 is perpendicular to the first direction D1. The second light-shading adhesive 16 is disposed within the light-blocking holes 134. Since the second light-shading adhesive 16 is filled in these light-blocking holes 134, the leakage of the light beam through the light-blocking holes 134 can be avoided. Moreover, the light-blocking holes 134 are formed as dark regions. Due to the dark regions, plural different luminous regions are defined on the luminous touch pad 1a.

In this embodiment, the light-blocking holes 134 are elongated holes. It is noted that the shape of the light-blocking hole 134 is not restricted. Preferably, the shape of the light-blocking hole 134 is determined according to the light-blocking requirements of the light guide structure 13a.

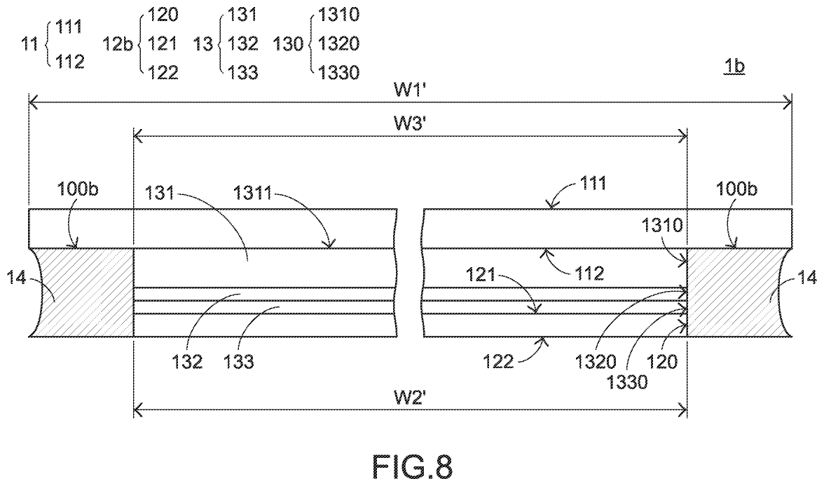

FIG. 8 is a schematic exploded view illustrating a luminous touch pad according to a third embodiment of the present invention. In comparison with the luminous touch pad 1 as shown in FIGS. 1, 2 and 3, the adhesive receiving space 100b of the luminous touch pad 1b of this embodiment is defined by a portion of the second surface 112 of the covering plate 11, an end surface 120 of the circuit board 12b and the lateral surrounding surface 130 of the light guide structure 13 collaboratively. The end surface 120 of the circuit board 12b is located beside the third surface 121 and the fourth surface 122 of the circuit board 12b. After the first light-shading adhesive 14 is filled in the adhesive receiving space 100b, the first light-shading adhesive 14 is arranged around the circuit board 12b and the light guide structure 13. In addition, the first light-shading adhesive 14 is contacted with the portion of the second surface 112 of the covering plate 11, the end surface 120 of the circuit board 12b and the lateral surrounding surface 130 of the light guide structure 13. In other words, the first light-shading adhesive 14 is attached on the portion of the second surface 112 of the covering plate 11, the end surface 120 of the circuit board 12b and the lateral surrounding surface 130 of the light guide structure 13. Consequently, the covering plate 11, the circuit board 12b and the light guide structure 13 are attached and fixed on each other. Moreover, due to the light-shading characteristics of the first light-shading adhesive 14, the leakage of the light beam through the lateral surrounding surface 130 of the light guide structure 13 can be avoided.

As shown in FIG. 8, the covering plate 11 has a first width W1′, the circuit board 12b has a second width W2′, and the light guide structure 13 has a third width W3′. In this embodiment, each of the second width W2′ of the circuit board 12b and the third width W3′ of the light guide structure 13 is smaller than the first width W1′ of the covering plate 11. In addition, the second width W2′ of the circuit board 12b is equal to the third width W3′ of the light guide structure 13. In other words, the lateral surrounding surface 130 of the light guide structure 13 and the end surface 120 of the circuit board 12b are coplanar with each other. Consequently, when the covering plate 11, the light guide structure 13 and the circuit board 12b are stacked on each other from top to bottom, the adhesive receiving space 100b is defined by the lateral surrounding surface 130 of the light guide structure 13, the portion of the second surface 112 of the covering plate 11 and the end surface 120 of the third surface 121 of the circuit board 12b collaboratively. Of course, the luminous touch pad 1b of this embodiment may be modified.

In a variant example of the luminous touch pad 1b, plural light-blocking holes are formed in the light guide structure 13. Like the structures of FIGS. 4 and 5, the second light-shading adhesive is formed in these light-blocking holes. Consequently, plural different luminous regions are defined on the luminous touch pad 1b.

From the above descriptions, the present invention provides the luminous touch pad. After the covering plate, the light guide structure and the circuit board are stacked on each other, the adhesive receiving space is formed in the edge regions of the covering plate, the light guide structure and the circuit board. In addition, the light-shading adhesive is directly filled in the adhesive receiving space through the dispensing process. Consequently, the covering plate, the circuit board and the light guide structure are attached and fixed on each other through the light-shading adhesive. Moreover, due to the arrangement of the first light-shading adhesive, the leakage of the light beam through the lateral surrounding surface of the light guide structure can be avoided.

The luminous touch pad has the following advantages. Firstly, the light-shading adhesive is used to replace the black light-shading frame of the conventional touch pad. Consequently, the stack structure with the double-sided tapes is not required. Since the covering plate, the circuit board and the light guide structure are attached and fixed on each other through the light-shading adhesive, the stack structure is simplified and thinned. Secondly, since the light-shading adhesive is used to replace the black light-shading frame of the conventional touch pad, the material loss problem of using the die-cutting process to create the black light-shading frame according to the conventional technology is solved, the number of fabricating steps is largely reduced, and the fabricating cost is effectively reduced. Thirdly, after the light-shading adhesive is solidified, the light-shading adhesive still has the property to be subjected to the tiny elastic change. Consequently, if the environment change of the product is drastic, the light-shading adhesive is not easily peeled off when compared with the double-sided tapes. Consequently, the light leakage problem will be avoided. Fourthly, the color of the light-shading adhesive is not restricted. As long as the light-shading adhesive is able to effectively shade the light beam, the color of the light-shading adhesive is not restricted.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A luminous touch pad, comprising:
a covering plate comprising a first surface and a second surface, wherein the first surface and the second surface are opposed to each other;
a circuit board located under the covering plate, and comprising a third surface and a fourth surface, wherein the third surface and the fourth surface are opposed to each other, and the third surface faces the second surface of the covering plate;
a light guide structure arranged between the covering plate and the circuit board, wherein the light guide structure comprises a lateral surrounding surface, and an adhesive receiving space is defined by the lateral surrounding surface, a portion of the second surface and a portion of the third surface collaboratively; and
a first light-shading adhesive disposed within the adhesive receiving space and arranged around the light guide structure, wherein the first light-shading adhesive is contacted with the portion of the second surface, the portion of the third surface and the lateral surrounding surface.

2. The luminous touch pad according to claim 1, wherein the light guide structure comprises a light-guiding plate, a reflective layer and an adhesive layer, which are stacked on each other from top to bottom, wherein the light-guiding plate is arranged between the covering plate and the reflective layer, the adhesive layer is arranged between the reflective layer and the circuit board, the light-guiding plate comprises a light-guiding plate lateral surface, the reflective layer comprises a reflective layer lateral surface, and the adhesive layer comprises an adhesive layer lateral surface, wherein the light-guiding plate lateral surface, the reflective layer lateral surface and the adhesive layer lateral surface are collaboratively formed as the lateral surrounding surface.

3. The luminous touch pad according to claim 2, wherein the light-guiding plate further comprises a light output surface and a bottom surface, wherein the light output surface and the bottom surface are opposed to each other, the light-guiding plate lateral surface is arranged between the light output surface and the bottom surface, the light-guiding plate lateral surface comprises a light input part, and the light input part comprises at least one notch.

4. The luminous touch pad according to claim 3, wherein the luminous touch pad further comprises at least one light-emitting element, wherein the at least one light-emitting element is disposed within the at least one notch of the light input part, the at least one light-emitting element is electrically connected with the circuit board, and the at least one light-emitting element emits a light beam, wherein the light beam is introduced into the light-guiding plate through the light input part, and the light beam is outputted from the light output surface.

5. The luminous touch pad according to claim 1, wherein the luminous touch pad further comprises a second light-shading adhesive, and the light guide structure further comprises plural light-shading holes, wherein the lateral surrounding surface is arranged around the plural light-shading holes, the plural light-shading holes are extended along a first direction, and the plural light-shading holes are discretely arranged along a second direction, wherein the first direction and the second direction are not in parallel with each other, and the second light-shading adhesive is formed in the plural light-shading holes.

6. The luminous touch pad according to claim 1, wherein the covering plate has a first width, the circuit board has a second width, the light guide structure has a third width, and each of the first width and the second width is larger than the third width, wherein when the covering plate, the light guide structure and the circuit board are stacked on each other from top to bottom, the adhesive receiving space is defined by the lateral surrounding surface of the light guide structure, the portion of the second surface of the covering plate and the portion of the third surface of the circuit board collaboratively.

7. A luminous touch pad, comprising:
a covering plate comprising a first surface and a second surface, wherein the first surface and the second surface are opposed to each other;
a circuit board located under the covering plate, and comprising a third surface, a fourth surface and an end surface, wherein the third surface and the fourth surface are opposed to each other, the end surface is arranged between the third surface and the fourth surface, and the third surface faces the second surface of the covering plate;
a light guide structure arranged between the covering plate and the circuit board, wherein the light guide structure comprises a lateral surrounding surface, and an adhesive receiving space is defined by the lateral surrounding surface, the end surface and a portion of the second surface collaboratively; and
a first light-shading adhesive disposed within the adhesive receiving space and arranged around the light guide structure and the circuit board, wherein the first light-shading adhesive is contacted with the portion of the second surface, the end surface and the lateral surrounding surface.

8. The luminous touch pad according to claim 7, wherein the luminous touch pad further comprises a second light-shading adhesive, and the light guide structure further comprises plural light-shading holes, wherein the lateral surrounding surface is arranged around the plural light-shading holes, the plural light-shading holes are extended along a first direction, and the plural light-shading holes are discretely arranged along a second direction, wherein the first direction and the second direction are not in parallel with each other, and the second light-shading adhesive is formed in the plural light-shading holes.

9. The luminous touch pad according to claim 7, wherein the lateral surrounding surface of the light guide structure and the end surface of the circuit board are coplanar with each other.

10. The luminous touch pad according to claim 7, wherein the covering plate has a first width, the circuit board has a second width, the light guide structure has a third width, each of the second width and the third width is smaller than the first width, and the second width is equal to the third width, wherein when the covering plate, the light guide structure and the circuit board are stacked on each other from top to bottom, the adhesive receiving space is defined by the lateral surrounding surface of the light guide structure, the portion of the second surface of the covering plate and the end surface of the circuit board collaboratively.
